(19) United States
(12) Patent Application Publication
(10) Pub. No.: US 2015/0178457 A1
(43) Pub. Date: Jun. 25, 2015

(54) GRAPHICAL USER INTERFACE FOR OBTAINING A RECORD OF A MEDICAL TREATMENT EVENT IN REAL TIME

(71) Applicant: KONINKLIJKE PHILIPS N.V., EINDHOVEN (NL)

(72) Inventors: Justin Grimley, Seattle, WA (US); Christian James Richard, Shoreline, WA (US)

(21) Appl. No.: 14/419,252

(22) PCT Filed: Jul. 26, 2013
(86) PCT No.: PCT/IB2013/056143

§ 371 Date: Feb. 3, 2015

Related U.S. Application Data
(60) Provisional application No. 61/679,897, filed on Aug. 6, 2012.

(51) Int. Cl. G06F 19/00; G06Q 50/24; G06F 17/30; G06F 3/0481; G06F 17/24

(52) U.S. Cl. CPC G06F 19/3418; G06F 3/04817; G06F 17/241; G06F 17/30312; G06F 19/322; G06Q 50/24

(57) ABSTRACT

A handheld medical event recorder (100) is described which incorporates a touch screen display (102) and a video camera (104). A graphical user interface on the touch screen display is arranged such that the user may annotate the medical event simply by touching an appropriate icon on the screen. The displayed icons and information are contextually appropriate to the medical event. Video of the medical event may be provided simultaneously with the graphical user interface.

The invention relates generally an improved apparatus and method for capturing information related to a medical treatment event, and for reviewing the information after the event. More particularly, the invention is a handheld computing device having a touch screen display for annotating the event and a video camera for recording the event. The user interface consists of contextually useful icons which, when touched, automatically record an annotation into memory. Video and the annotations may be transferred to a central computer for further processing and analysis subsequent to the medical event.

Emergency medical procedures have been studied by the medical establishment for many years. It is commonly understood that patient outcomes can be improved by modifying procedures, by eliminating harmful or unnecessary steps, or by training personnel who are not performing the procedures correctly. A typical study involves the assignment of an observer who records the time and manner of the actions taken during the medical event. In some cases, equipment which is used in the event automatically generates time-ordered logs of recorded data as well.

One example of a medical event is the emergency treatment of sudden cardiac arrest (SCA). SCA is a leading cause of death in the United States. In about 40% of sudden cardiac arrest (SCA) patients, the initial cardiac rhythm observed is ventricular fibrillation (VF). CPR is the protocol treatment for SCA, which consists of chest compressions and ventilations that provide circulation in the patient. Defibrillation is interposed between sessions of CPR in order to treat underlying VF. It is known that the probability of a successful patient outcome depends upon the quality and timeliness of CPR and defibrillation. Unfortunately, many events lack both of these factors. Thus, the study and evaluation of SCA medical treatment events is of considerable importance to medicine.

FIG. 1 illustrates a prior art SCA medical treatment event in which the electrodes 16 of a prior art defibrillator 10 have been applied by a rescuer 12 to resuscitate a patient 14 suffering from cardiac arrest. The defibrillator 10 may be in the form of an AED capable of being used by a first responder. The defibrillator 10 may also be in the form of a manual defibrillator for use by paramedics or other highly trained medical personnel in a hospital environment.

In sudden cardiac arrest, the patient is stricken with a life threatening interruption to the normal heart rhythm, typically in the form of VF or VT that is not accompanied by spontaneous circulation (i.e., shockable VT). If normal rhythm is not restored within a time frame commonly understood to be approximately 8 to 10 minutes, the patient will die. Conversely, the quicker that circulation can be restored (via CPR and defibrillation) after the onset of VF, the better the chances that the patient 14 will survive the event. It is thus a matter of great interest to the administrators who oversee the medical response organization that the rescuers perform the resuscitation quickly and effectively.

Most EMS and hospital organizations prepare incident reports of medical treatment events in order to conduct post-event reviews. Incident reports are typically constructed from manual reports filled out by on-scene observers. The reports are often augmented by data automatically collected by the defibrillator used at the scene. The data automatically provided by a defibrillator, for example, typically includes an ECG strip, a recorded time of defibrillator activation, the initiation of CPR, delivery of defibrillation shocks, and so on. In addition, an audio record (“voice strip”) that documents the verbal remarks of the first responders is often recorded by the defibrillator.

Automatically generated data, however, cannot capture all of the important information about the progress and effectiveness of the rescue. Hence there is a need for a manual report that is produced by an on-scene observer. The manual report may document information such as the names of the rescue team, the equipment used, the observed quality of CPR compressions and ventilations, drugs administered, patient responsiveness to rescue efforts, and the times of each of these events. This data must be collected and manually merged with the automatically generated data in order to provide a comprehensive and accurate record of the event.

All of this event data which is generated by the various sources is merged together to form the incident report at a centralized computer using software such as the Event Review software sold by the Healthcare division of Philips Electronics North America Company of Andover Massachusetts. FIG. 2 illustrates a typical prior art incident report generation screen 20. As shown there, the user views the automatically generated data on one tab. The user then works from the event's other manual reports to enter notes and annotations about the treatment onto the software screens. Despite the computer software, this process of manually generating an incident report is inconvenient and time-consuming. The end product may also not reflect the overall effectiveness of the treatment event because of errors or omissions in the manual reports, the need for post-event reconstruction necessitated by the haste and urgency of the rescue event, or by a lack of time-synchronization of the manual and automated sources of data.

One solution to the problem of accurately documenting a medical treatment event may lie with the ubiquitous handheld computing device. These compact devices, such as commercially available smartphones, include touch screen displays, video cameras, microphones, and wireless communication capabilities. The handheld computing devices could be used at the scene by the observer to record the progress of the treatment, and to create a diary of the rescue. Unfortunately, today's audio/video and hand-entered data is not automatically consolidated into one event log by the prior art devices. Nor are the data entry screens and the video record displayed simultaneously. Thus, significant time and effort must be expended to create a meaningful incident report from this information.

What is needed therefore to address each of these deficiencies in the prior art is a device and method which offers a simplified data entry interface for recording important information during a medical treatment event. The interface should be capable of generating annotated event logs through the selection of contextually relevant icons on the touch screen. The device preferably merges audio and video records of the event with the annotated event logs. The device would be particularly useful in the documentation of CPR during cardiac arrest.

Similarly, what is needed is an improved graphical user interface for a handheld computing device which facilitates an accurate and thorough documentation of a medical treatment event. The graphical user interface should be intuitive and should require a minimum of manipulation to record important event information.

What is also needed is a system which efficiently and accurately conveys collected event logs to a central location for editing and review by medical administrative staff. Such a system would improve patient outcomes by enabling the staff to adjust procedures, add resources to future events, or identify needed training of personnel.

In accordance with the principles of the present invention, an improved device and method for recording a medical treatment event in real time and for transferring the record to a central location for analysis and review is described. Accordingly, it is an object of the invention to provide a handheld computing device having a novel computer program resident on the device that provides icons on a touch screen for rapidly entering relevant information during the event. The device also preferably includes video recording capability. The method provides for the generation of annotations from the touch screen entries and for constructing an event log from the annotations and from the audio/video records.

It is another object of the invention to describe a graphical user interface (GUI) for use with a handheld computing device for generating and storing annotations about a medical treatment event in an event log. The GUI preferably operates on a touch screen display showing icons that are contextually relevant to the current protocol step in the medical treatment. The icons that are presented to the user change as information is entered.

It is yet another object of the invention to describe an improved system and method for transferring event logs from a handheld computing device to a central computer. Preferably, the transfer is conducted wirelessly. A remote server, known as a cloud server, may provide an intermediate data storage capability for the event logs. The central computer preferably operates under a novel computer program which combines event annotations with video to provide a comprehensive record of the medical treatment event. If not already combined, the central computer may optionally merge data from a therapeutic device used in the event, such as a defibrillator, to recreate a more comprehensive report.

### IN THE DRAWINGS

FIG. 1 is an illustration of a defibrillator which is in use with a patient suffering from cardiac arrest.

FIG. 2 illustrates the display of a prior art medical event review software program, showing an event log of annotations and ECG as provided by a defibrillator.

FIG. 3 is a functional block diagram of a handheld computing device for recording a medical treatment event in real time.

FIG. 4 illustrates an exemplary handheld computing device in use during a medical treatment event.

FIG. 5, panels 5a through 5d, illustrate a structural flow diagram which maps the GUI screens according to one embodiment of the invention.

FIG. 6 illustrates one embodiment of the settings screen.

FIG. 7 illustrates one embodiment of the introduction screen.

FIG. 8 illustrates one embodiment of the items screen.

FIG. 9 illustrates one embodiment of an annotations screen.

FIG. 10 illustrates the select drugs screen embodiment of the present invention.

FIG. 11 illustrates one embodiment of a modify drugs list screen.

FIG. 12 illustrates an add drugs screen embodiment of the invention.

FIG. 13 illustrates an additional information screen as displayed on the handheld device of the present invention.

FIG. 14 illustrates one embodiment of a team members screen

FIG. 15 illustrates one embodiment of an add team member screen.

FIG. 16 illustrates one embodiment of a team member roles entry screen.

FIG. 17 illustrates one embodiment of a scan barcode screen.

FIG. 18 illustrates one embodiment of an additional information screen with a device detected indication.

FIG. 19 illustrates one embodiment of an event logs screen.

FIG. 20 illustrates one embodiment of an event log entries screen.

FIG. 21 illustrates one embodiment of an event log actions screen.

FIG. 22 illustrates one embodiment of an event log preview screen.

FIG. 23 illustrates a communications systems overview according to one embodiment of the present invention.

FIG. 24 illustrates one embodiment of an annotations preview screen as provided on a central computer display.

FIG. 25 illustrates one embodiment of a location preview screen as provided on a central computer display.

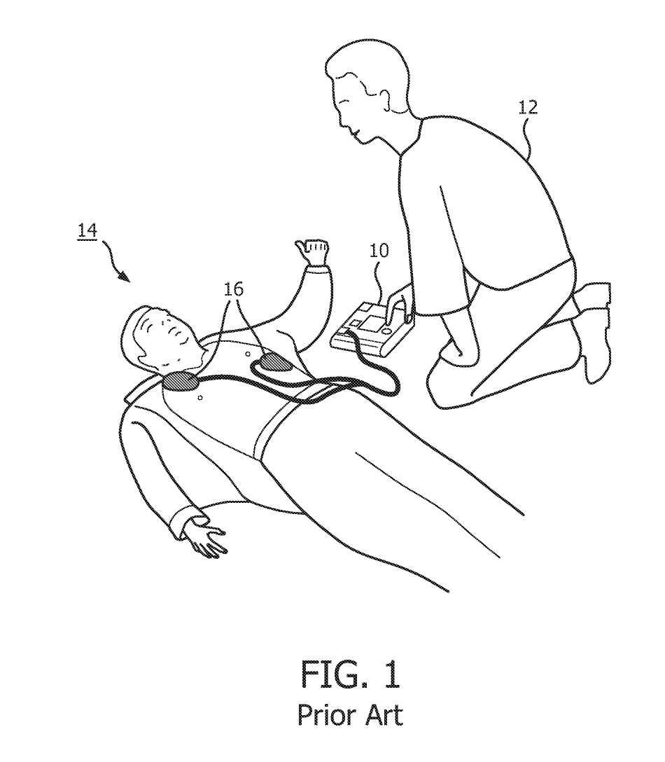

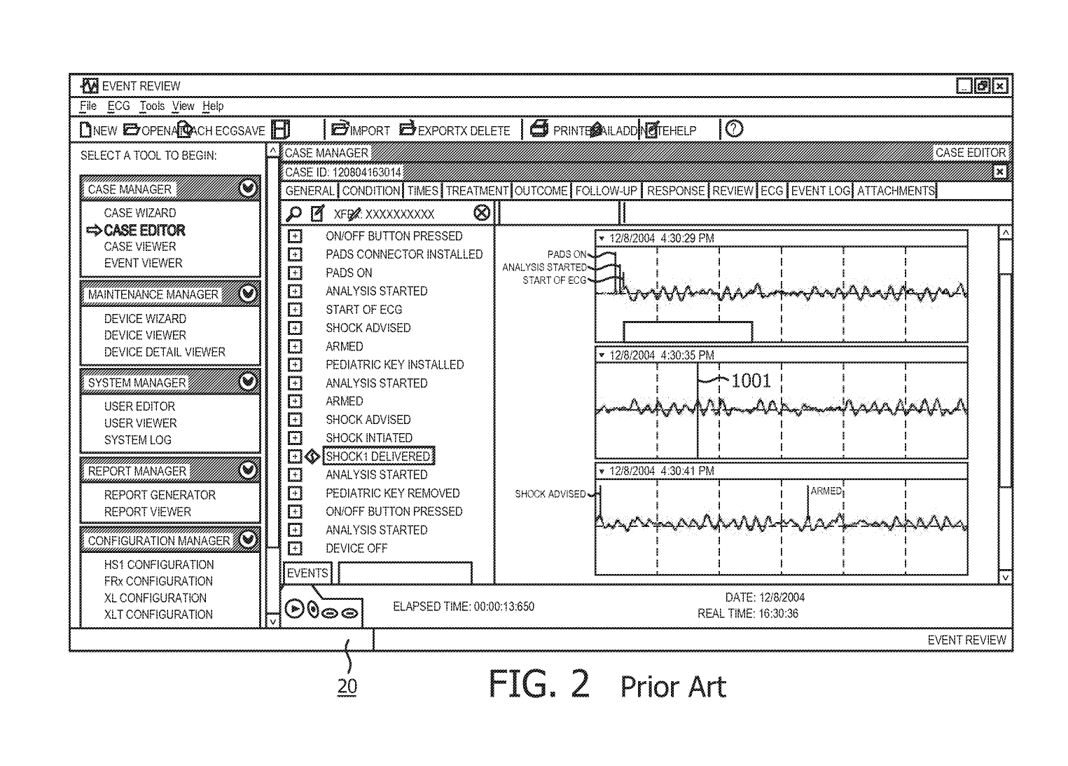

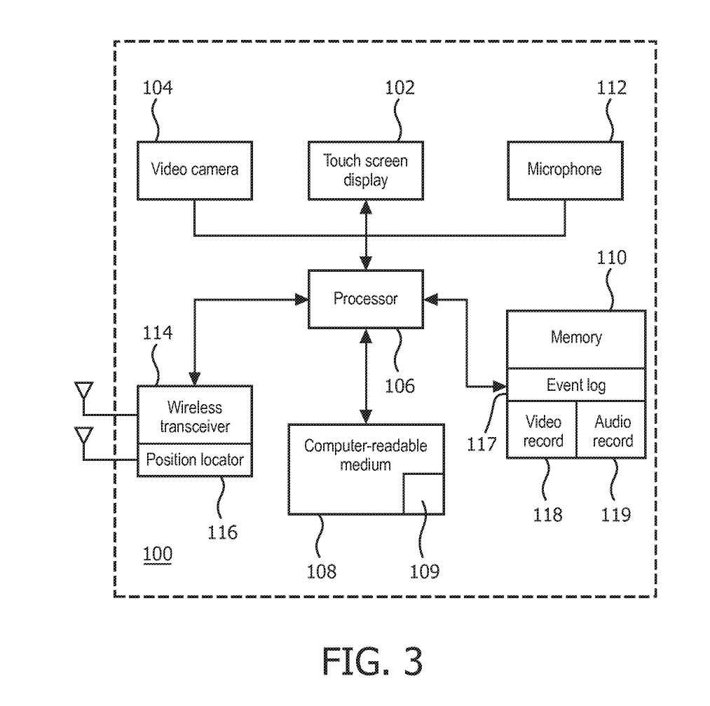

Now turning to the drawings, FIG. 3 illustrates a block diagram of an exemplary handheld computing device 100 for recording a medical treatment event in real time. The computing device maybe of custom manufacture. Preferably, an implementation of the invention uses off-the-shelf hardware such as that of a smartphone with the addition of a novel computer program that enables the intended operation. The device computer program is an event capture software application 109. The handheld computing device 100 comprises a touch screen display 102, a video camera 104 operable to capture a video record 2120, and a processor 106 operated by the application 109 residing on a computer-readable medium 108. The device may optionally comprise a microphone 112 operable to capture an audio record 119. A memory 110 is operable to store an event log 117, a video record 118 of the event, and an audio record 119 of the event. Preferably, the video record 118 and audio record 119 are correlated with or integrated into event log 117, such that event log 117 contains all relevant information about the event. The device may also include a wireless transceiver 114, such as a wireless internet interface (WIFI) or a wireless telephone interface. The wireless transceiver may also include a position locator 116, such as a global positioning system (GPS) receiver or the like. The device of FIG. 3 is preferably arranged to allow a user to video a medical treatment event while simultaneously entering event data on the touch screen display.

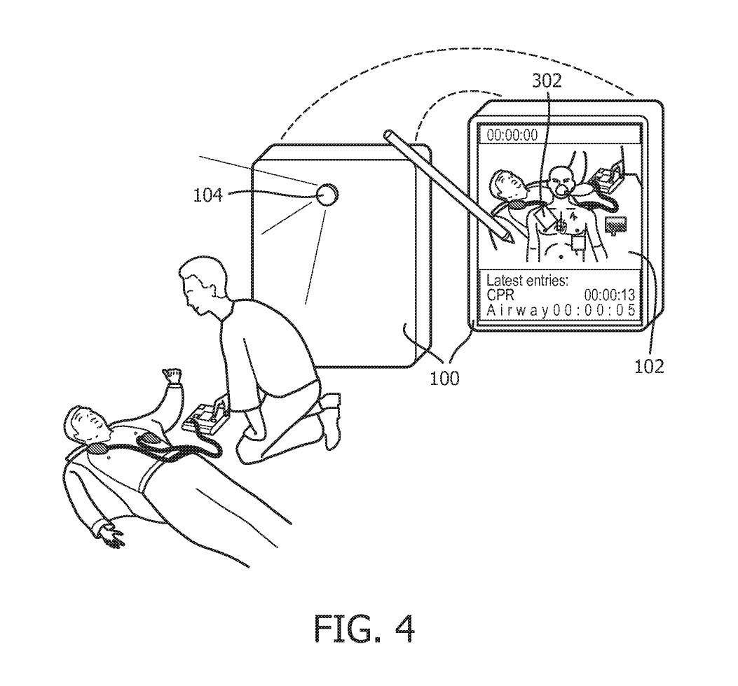

An exemplary arrangement of such a device in use is shown in FIG. 4. FIG. 4 illustrates how the handheld computing device 100 enables an observer/recorder, holding the device, to record a medical treatment event being performed by a rescuer on a patient. A pen-type selector is shown for selecting annotation icons on the touch screen display 102, although finger-tapping of the icons is often the preferred method. In the preferred embodiment, one side of device 100 is disposed with the video camera 104 for recording the event. The other side of device 100 is disposed with the touch screen display 102, on which the user may tap touch-sensitive annotation icons, such as defibrillator electrode pad icon 302. As can be seen on the touch screen display 102, the annotation icons and graphics overlay the video display as it is being recorded. Microphone 112, not shown, simultaneously captures an audio record. The graphical user interface (GUI) on the touch screen display 102 is intended to be used to enter details about the event as they occur. The video record and captured data is stored in the device memory. The GUI is described in more detail below.

The user initializes the recording by a touch of a start button or any of the annotation icons on the GUI. An elapsed time counter on the GUI then begins to show the elapsed time from the beginning of the event.

The handheld computing device can enable many types of information to be conveniently entered through the GUI. Annotation of events during the treatment are entered via annotation icons on the touch screen. Pop-up screens for entering more detailed information about the event may also be provided. Screens for entering administered drugs, medical treatment team members and roles, and on-scene equipment lists and status, may be pre-populated with selection candidates during setup. Thus, the device enables quick entry of this information during the event without the need for manually entering text.

A handheld computing device of the present invention is optionally configured such that many types of information can be obtained automatically. Device 100 may include a barcode or QR code reader which automatically identifies readable codes that are in the video field of view. The device 100 may prompt the user to obtain the code, thereby capturing equipment and/or data associated with the code into an event log 117. Device 100 may include a positioning locator, such as a GPS receiver, which logs position information into the event log 117. Also, the device may include a wireless interface that is compatible with certain medical devices, for example a defibrillator, such that the device can obtain and record data captured by the medical device directly into the event log. Such features significantly reduce the time and effort involved in consolidating important multiple-sourced information about the event, and considerably improve the accuracy and precision of the consolidated information.

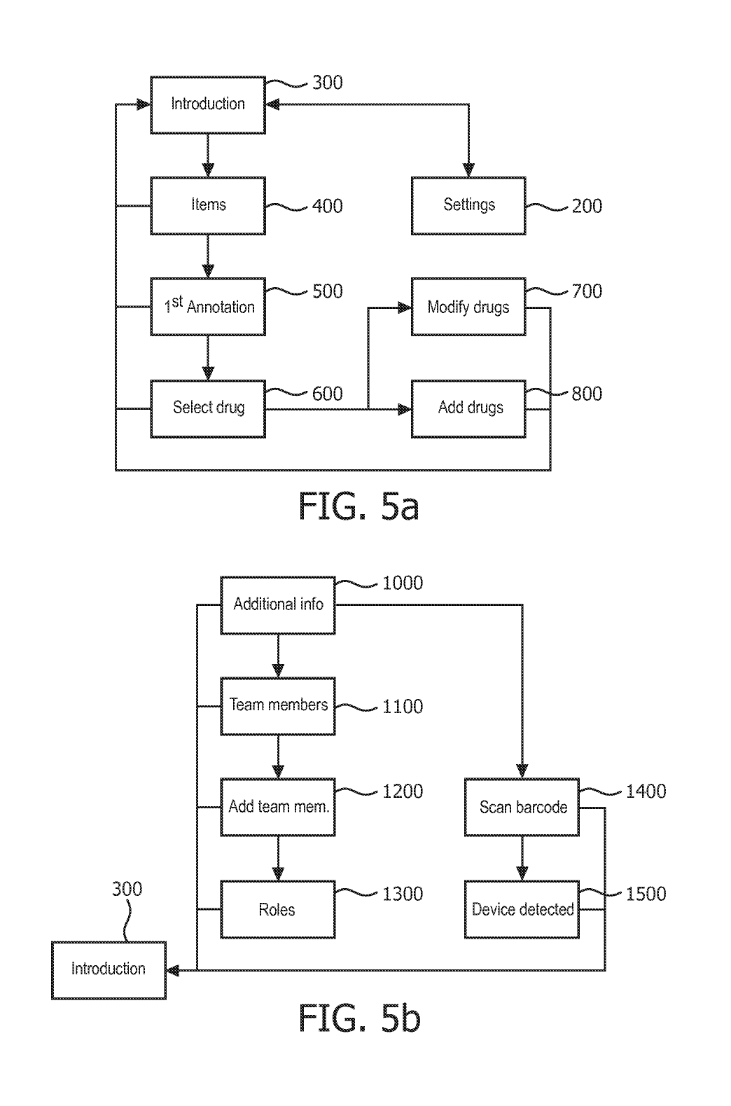

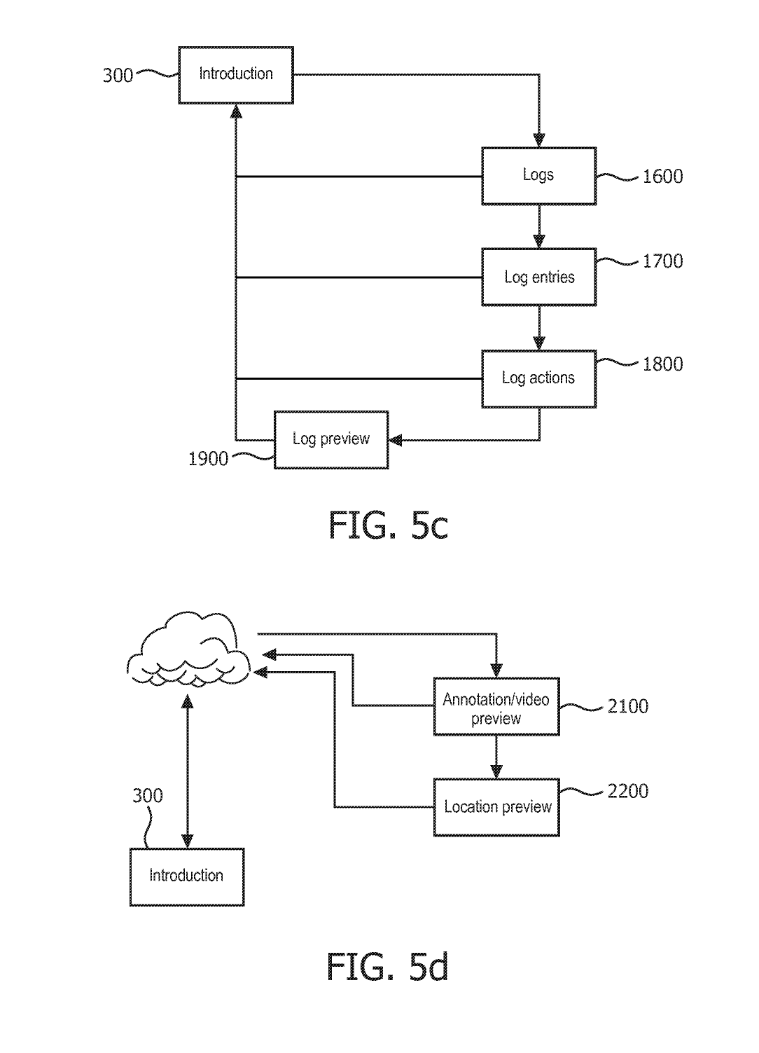

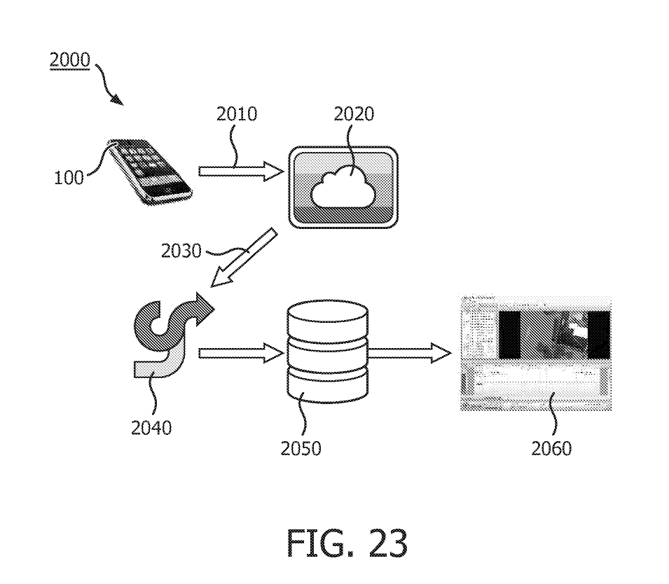

FIGS. 5a through 5d illustrate a structural flow diagram which maps the GUI screens according to one embodiment of the invention. The flow diagram corresponds generally to instructions provided by an event capture software application 109 in device 100, and by a computer program residing in central computer 2050 (see FIG. 23). The application and program can be arranged as functional modules, each of which contains software instructions for particular functions. The user navigates between functional modules by clicking on touch-sensitive icons on contextually-relevant display screens, which brings the user to the next logical screen. Arrows shown in FIG. 5 between the various modules represent one possible path of navigation through the screens, and of information flow back to earlier screens for display. The screens which are displayed on the handheld computing device 100 include a settings screen 200, an introduction screen 300, an items screen 400, an annotation screen 500, a select drug screen 600, a modify drugs screen 700, an add drugs screen 800, an additional information screen 1000, a team members screen 1100, an add team member screen 1200, a roles screen 1300, a scan barcode screen 1400, a device detected screen 1500, a logs screen 1600, a log entries screen 1700, a log actions screen 1800, and a log preview screen 1900. The screens which are displayed on the central computer 2050 include an annotation and video preview screen 2100 and a location preview screen 2200. These screens on the central computer and their data may be communicatively coupled to the screens on the handheld computing device 100 via known wireless means, such as via a cloud server. Each screen and its relation to the other screens are now described in detail.

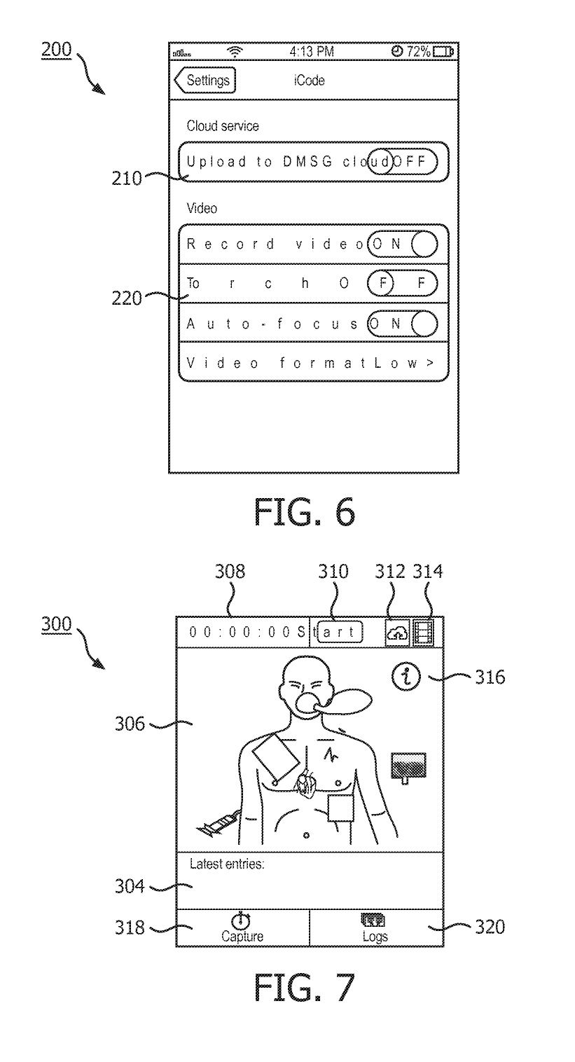

Turning now to FIG. 6, an exemplary settings screen 200 is shown. The settings screen 200 is accessed from a general settings section of the handheld computing device 100. Screen 200 allows the user to configure the resident computer program to establish an upload setting 210 for enabling/disabling upload to a remote computer, such as a cloud server. If the upload setting 210 is enabled, device 100 initiates the upload of the correlated event log 117 automatically when the event recording ends or at the acceptance of the event log after a preview by the user. Screen 200 also allows the user to set the configuration for the video camera 104 video at video setting 220. At video setting 220, the user can enable/disable video recording altogether, optionally enable a flashlight “torch” to turn on automatically in low light conditions, and set auto focus and video formats. Preferably, the user establishes these settings before the medical treatment event begins.

FIG. 7 illustrates an introduction screen 300, which is the first screen presented when the user initializes the handheld computing device 100 and software application 109 to record the medical treatment event. Introduction screen 300 is arranged in four main parts. A top ribbon displays a start button 310, which the user taps to begin recording the event. An elapsed time counter 308 shows elapsed time from the beginning of the event recording. An indicator 312 indicates whether or not cloud storage is enabled, and may also indicate that the recording will be uploaded to the cloud storage location automatically when the recording is stopped. A video status indicator 314 displays whether or not video is being recorded.

A large data entry screen 306 in the center of screen 300 serves as the primary annotation space for user input. Touch-sensitive annotation icons are arranged on data entry screen 306 in logical fashion around a human shaped graphic 322, preferably in the shape of a human torso. The user may drill down to provide additional and more detailed annotations by tapping on an information button 316.

Data entry screen 306 also provides an ongoing video display as recorded by camera 104, preferably in the background behind the touch-sensitive annotation icons and the human shaped graphic 322. Preferably, the video display begins immediately when the device is turned on and regardless of whether the user has started recording the event. FIG. 7 shows an alternate embodiment wherein video is not displayed behind the data entry screen 306 until recording is activated.

Annotation list box 304 shows the most recent user annotations preferably as a scrolling list, which can be swiped by a finger of the user to scroll down through the list.

A bottom ribbon tab control on screen 300 allows the user to quickly navigate to either of two main pages in the computer program by means of a capture icon 318 and a log history selector icon 320. The capture icon always brings the user back to the introduction screen 300, which is the main screen used for recording video and annotations. The screen accessed by the log history selector icon 320 is a screen used for selecting previously recorded log entries. After navigating to the introduction screen 300 the user can touch either the start button 310 or any annotation icon (drugs, CPR, etc.) to activate the camera 104 and the microphone 112. The user may review past event logs recorded in memory 110 by touching the log history selector 320.

Referring to FIG. 7, the user activates the camera 104 and microphone 112 by either tapping on the start button 310 or by tapping any icon on the data entry screen 306. Upon activation, the device begins to record video of the event that is being shown simultaneously behind the annotation icon graphics on the data entry screen 306. The software also obtains an audio record of the medical treatment event using the microphone 112. The device stores both video record and the audio record in memory 110.

After the event recording is activated by the user, the computing device begins to obtain video and audio records and the elapsed time counter starts. In addition, the device displays items screen 400 which displays one or more touch-sensitive annotation icons corresponding to the first step of a medical treatment protocol relating to the event on the display screen 306. The device 100 senses a touch of an annotation icon, and records a corresponding annotation into memory 110.

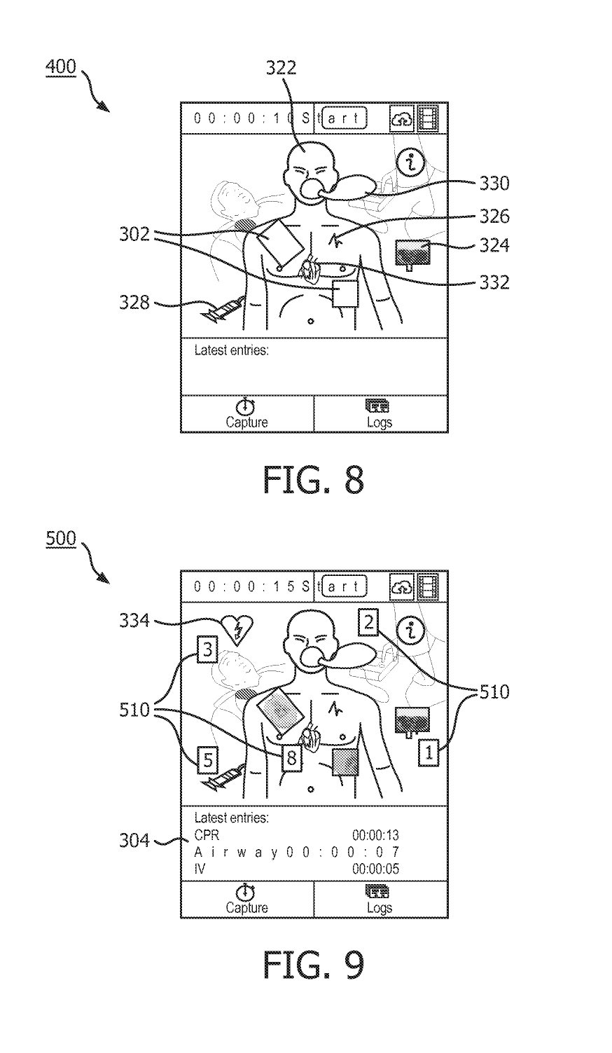

FIG. 8 illustrates one embodiment of the items screen 400, in which the medical treatment event is a cardiopulmonary respiration (CPR) treatment that follows the steps of a CPR protocol. The current video obtained by the video camera 104 is displayed in the background of the data entry screen 306 so that video and annotation can be accomplished simultaneously without the need for averting the user's eyes from the screen.

Several touch-sensitive annotation icons are shown in FIG. 8, each of which represents an activity portion of the CPR protocol. The user taps each icon as its activity occurs during the rescue. For example, when the attending rescuer applies each defibrillator electrode pad to the patient, the user taps either or both of the defibrillator electrode pad icons 302. When ventilations are performed on the patient, the user touches the ventilation icon 330. When a set of compressions is applied to the patient, a touch of the chest compression icon 332 records the start time of compressions, and when touched again, records the stop time of compressions. During the administration of chest compressions the chest compression icon may flash or turn color to indicate that chest compressions are ongoing. When a return of spontaneous circulation (ROSC) is noted, or its status changes, the user touches the ROSC icon 326. When IV fluids are administered to the patient, the user taps the IV therapy treatment icon 324. When a therapeutic agent is administered to the patient, the user touches the syringe icon 328. As the device 100 senses each touch of an icon, the device 100 records the related annotation activity and the time.

The GUI is preferably configured such that an annotation icon changes in appearance when the icon is touched. Thus, the user has a visual indication in the appearance that the particular step of the medical treatment protocol is underway or has been completed. A touched icon may change to take on the appearance of a different color, contrast, brightness, size, graphic design or the like. The electrode pad icon 302, for example, may add printed graphics inside the outline of the pads to indicate that the pads are attached.

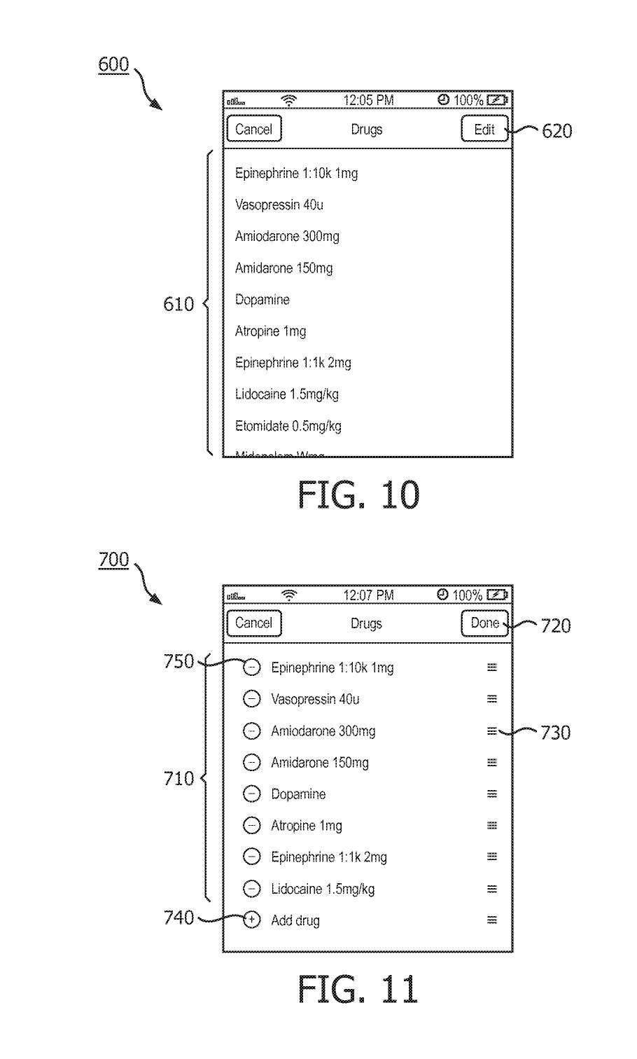

The GUI may also be configured to show a second annotation icon or screen in response to a touch of the annotation icon. For example, the processor may enable the GUI to display a touch-sensitive defibrillation shock delivery icon 334, shown in FIG. 9, upon a touch of the electrode pad icon 302 indicating that defibrillator electrodes have been attached to the patient. The user can then touch the shock icon 334 when a defibrillating shock is administered. Similarly, responsive to a touch of the syringe icon 328, the processor may cause the GUI to bring up a touch-sensitive select drugs screen 700, shown in FIG. 10.

Also illustrated in the annotation screen 500 of FIG. 9 are one or more annotation counters 510. Each annotation counter 510 is situated adjacent its respective annotation icon to provide an indication as to how many times the icon has been touched during the current event. Each time the respective icon is touched, the annotation counter 510 for that icon is incremented. At the same time, the annotation and time are appended to the top of the annotation list box 304. The annotation list box is preferably operable to be manually scrolled using a known “swipe” gesture across the list.

Alternatively, annotation counter 510 could be incremented only when the underlying action begins. For example, annotation counter 510 for chest compressions (box “8” in FIG. 9) could be incremented only at a tap which indicates that compressions have begun, and subsequently ignores the next tap that indicates that compressions for the set have ended.

FIG. 10 illustrates a drugs screen 600 which is activated when the user touches syringe icon 328 on the items screen 400. The drugs screen 600 is preferably arranged to display a drug list 610 of therapeutic agents and standard administered doses corresponding to the selected medical event protocol, the list preferably being arranged in a logical order. For example, the agents may be listed in the order that they are expected to be administered, or they may be listed in alphabetical order. Device 100 senses a touched selection by the user of one the drugs that has been administered, and records an annotation as to that substance and amount into event log 117 along with the current elapsed time. The action will also be displayed on the annotation list box 304, and the user will be returned to the annotation screen 500. If a therapeutic agent or amount differs from the standard protocol, the list can be modified by tapping the edit drug list icon 620, upon which the processor 106 displays the modify drugs screen 700.

A modify drugs screen 700 is illustrated in FIG. 11. Preferably, this screen is accessed prior to the medical treatment event to optimally arrange the appearance and contents of the drug list 610. The modify drugs screen 700 duplicates the drug list 610 with drug list 710 in order to allow modification of the list. Modify drugs screen 700 allows the user to quickly rearrange the displayed order of the therapeutic agents by dragging a rearrange drug icon 730 to a desired location in the list. Once the order is set on drug list 710, the order persists on drug list 610. The user may delete therapeutic agents by tapping on a remove drug icon 750 to the left of the therapeutic agent. If the user taps the add drug icon 740 on the modify drugs screen 700, the processor displays an add drugs screen 800. When the arrangement and contents are satisfactory, the user taps the done icon 720 to return to the select drug screen 600.

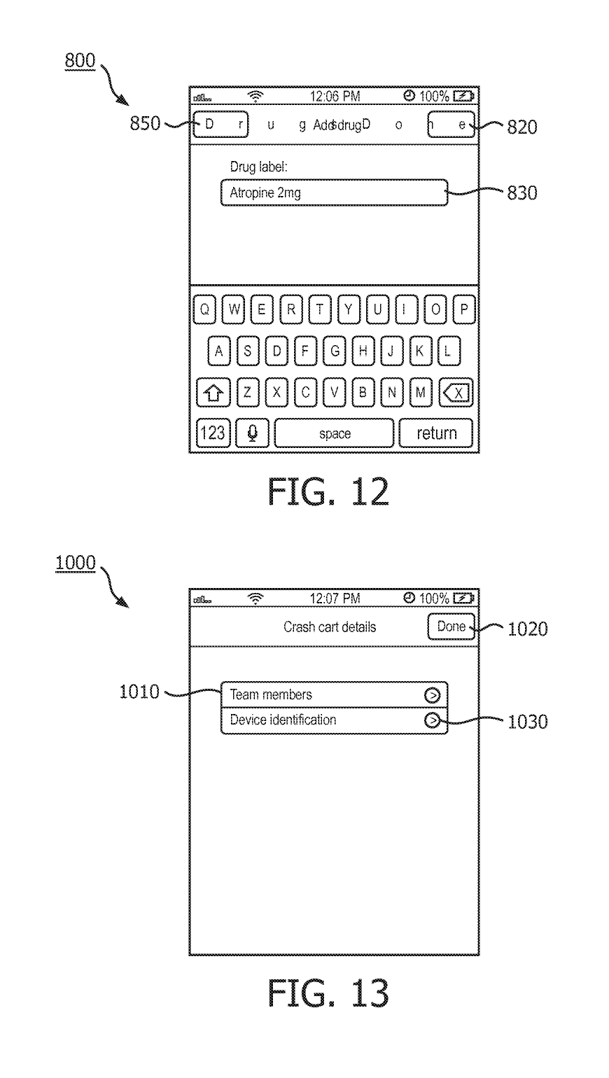

The add drugs screen 800 is illustrated in FIG. 12. An add new drug text box 830 is displayed, in which the user may enter a new therapeutic agent and dosage amount via a touch-sensitive keyboard graphic displayed on the bottom portion of screen 800. When the entry is complete, the user taps the Done icon 820. After a new drug has been added, the user taps the return to drugs list icon 810 to return to the previous display 700. The user may then move the new drug to a desired location in the drug list 710.

FIG. 13 illustrates an additional information screen 1000 that is displayed on the touch screen responsive to the user touching the information button 316 on introduction screen 300. The information button 316 may also be referred to as the crash cart icon 316. The FIG. 13 embodiment carries the header “crash cart details” to indicate that the additional information comprises the team members and ancillary equipment that are involved in the medical treatment event. Alternative to the information button 316, the screen 1000 may be accessed by a dedicated crash cart button displayed on the introduction screen 300. As shown in this example, the user can select either a team members icon 1010 or a device identification icon 1030, which causes the screen sequence to navigate to the team members screen 1100 or device scan barcode screen 1400 respectively. Once the desired event data is logged at those screens, the user taps the done icon 1020 to return to the introduction screen 300.

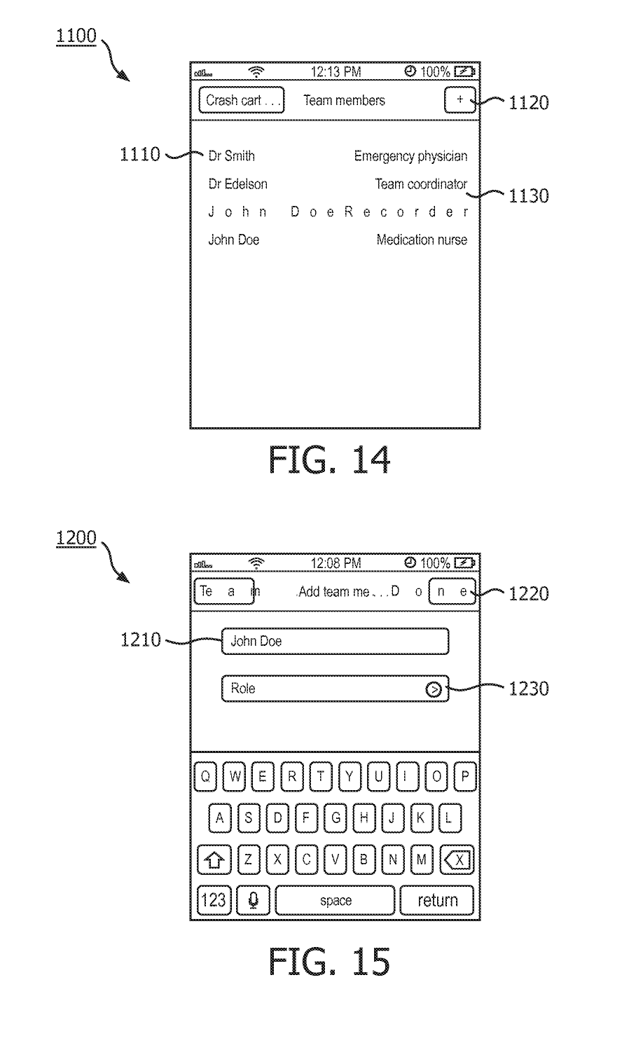

FIG. 14 illustrates one embodiment of a team members screen 1100 which is displayed responsive to a tap of the team members icon 1010 on the previous additional information screen 1000. The team members screen 1100 lists team members names 1110 and roles 1130 for the medical treatment event. The user simply touches a name 1110 to select the team member that is participating in the medical treatment event, whereupon the application stores the annotation of name and role in the event log 117. When all team member information is recorded, the user taps the “crash cart . . . ” icon to return to the previous additional information screen 1000. If the user desires to add a new team member, or to adjust the role of a currently-listed team member, she taps the add new member icon 1120, whereupon the application advances to the add team member screen 1200.

FIG. 15 illustrates one embodiment of an add team member screen 1200. The processor brings up a member name entry box 1210, in which the user may enter a new team member name via a touch-sensitive keyboard graphic displayed on the bottom portion of screen 1200. The user then selects a role for that team member by touching member role icon 1230 to navigate to the roles screen 1300, or may simply enter the role using the graphic keyboard. When the entry is complete, the user taps the done icon 1220 to return to the previous display.

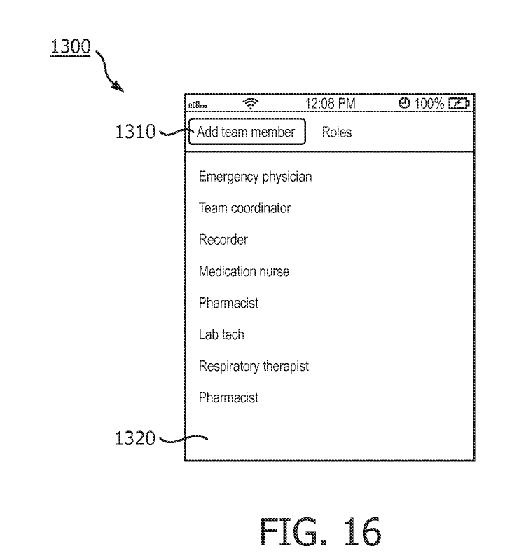

FIG. 16 illustrates one embodiment of a team member roles entry screen 1300. Preferably the list of roles in role selector 1320 is standard to the medical organization and will rarely need to be adjusted. The user selects a role for a team member from the role selector 1320 and then touches the add team member icon 1310 to return to the previous display.

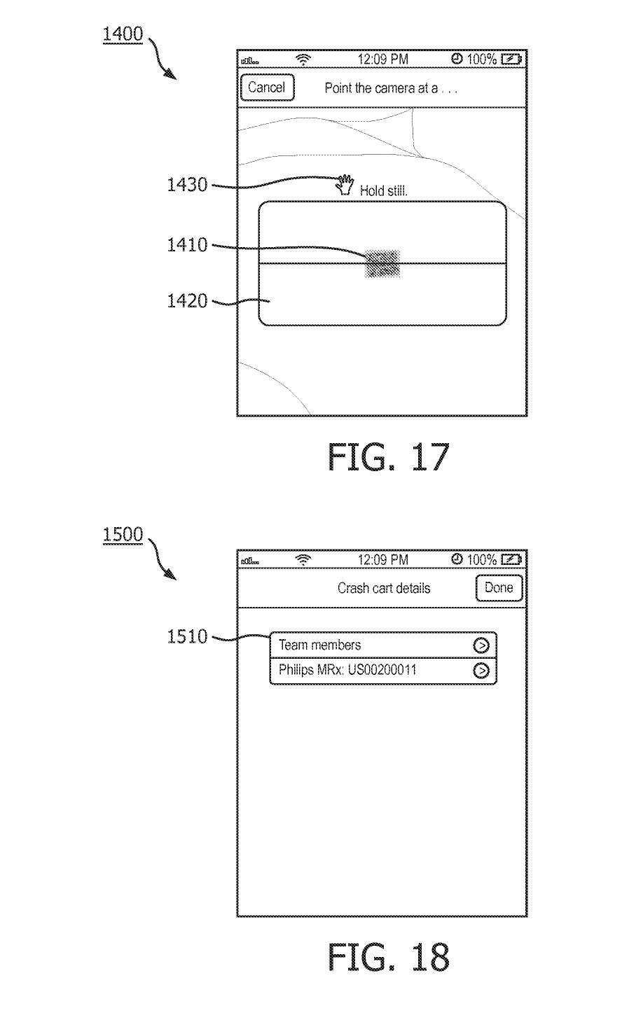

FIG. 17 illustrates one embodiment of device scan barcode screen 1400 for assisting the user in obtaining information pertaining to equipment that is used in the medical treatment event. The equipment may be a medical device which includes a barcode-type identifier, such as a standard UPC barcode or a matrix or Quick Response (QR) code. These codes are often applied to the exterior of medical devices in order to allow efficient tracking within the medical organization and for regulatory purposes. Barcode screen 1400 exploits this situation, by enabling the automatic detection and identification of such medical devices during the event, by annotating corresponding log entries, and by providing follow-on opportunities to merge equipment-related event logs with the event logs generated by the handheld computing device 100. The equipment identifier is commonly the medical device serial number.

For illustrative purposes, FIG. 17 shows a QR code disposed on the exterior of a defibrillator that is in use at a medical treatment event. As the user navigates to barcode screen 1400, processor 106 activates video camera 104 and barcode reader instructions 1430 for automatically identifying barcodes in the video field of view 1420. When processor 106 recognizes a readable QR code 1410, it obtains the barcode via the camera and barcode reader, and automatically identifies the medical device based upon the obtained barcode. The processor 106 then records an annotation of the medical device information and read time into the event log 117, and places the medical device name in the annotation list box.

If the QR code 1410 image is too unstable to be accurately read, device 100 issues a hold still prompt 1430 for the user to steady the camera. After the image is recognized, the device 100 issues a confirmation prompt and automatically returns to the additional information screen as shown by device detected screen 1500 in FIG. 18. This screen illustrates a detected device identity 1510, in this case the model and serial number of a defibrillator is displayed.

By capturing the identity of equipment used in the medical treatment event, any information that is being simultaneously captured by the equipment can also be captured or synchronized with the event log 117. In one embodiment, device 100 establishes wireless communications with the equipment via a handshake protocol. Then device 100 begins to wirelessly communicate with the identified medical device via the wireless transceiver 114, enabling device 100 to capture event data from the medical device directly. The communication between the medical device and device 100 is via known wireless communications means, such as Bluetooth, Wi-Fi, or infrared (IRDA). The defibrillator example described previously can provide shock decision and delivery data, and CPR data in real time with the event. The wireless signal may also provide information representative of a patient characteristic, such as an ECG. If batch communications are desired, time markers for each data event are generally provided by the medical device. If equipped with a microphone, the defibrillator can also provide an audio record of the event to device 100. The data corresponding to the wireless signal transmissions is then recorded into the memory 110.

This means of correlating defibrillator data with a handheld computing device is described in more detail in co-assigned U.S. Patent Publication 2008/0130140A1 entitled “Defibrillator Event Data with Time Correlation”, which is incorporated herein by reference. All of the information acquired from another medical device may be synchronized by device 100 with the information recorded directly by device 100 and integrated in a time sequence in event log 117. In addition, the data corresponding to the wireless signal may be displayed on the introduction screen 300 simultaneously with the annotation icons.

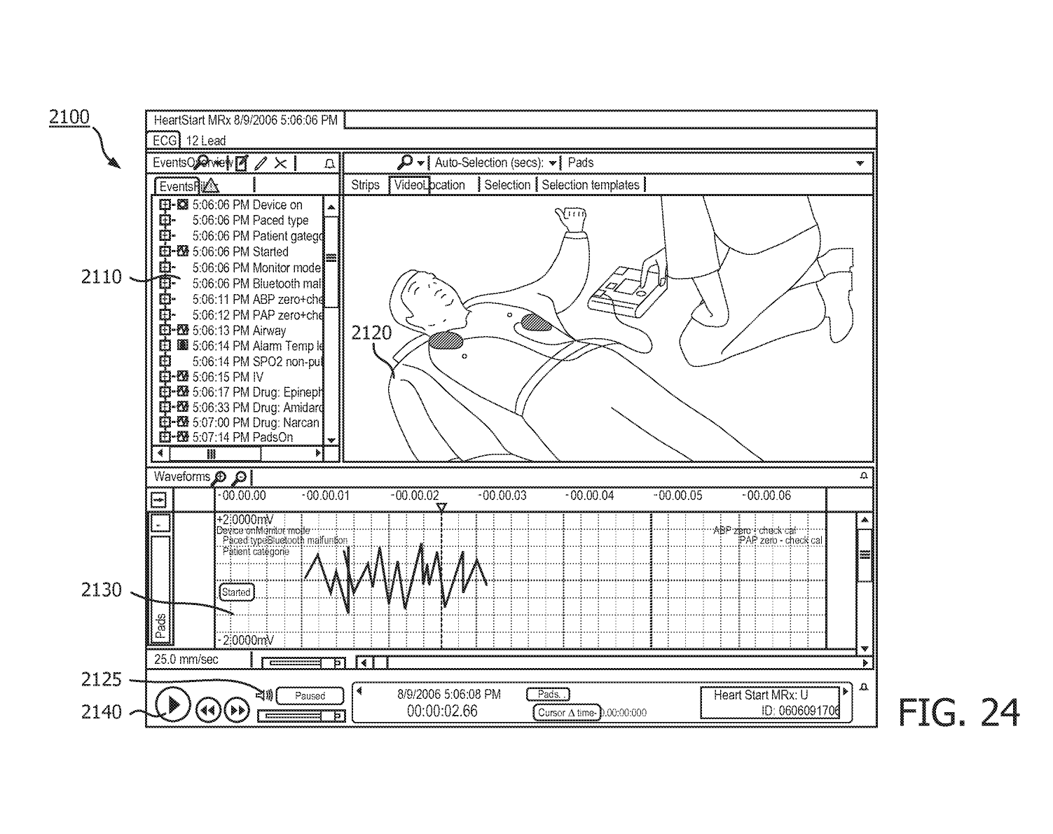

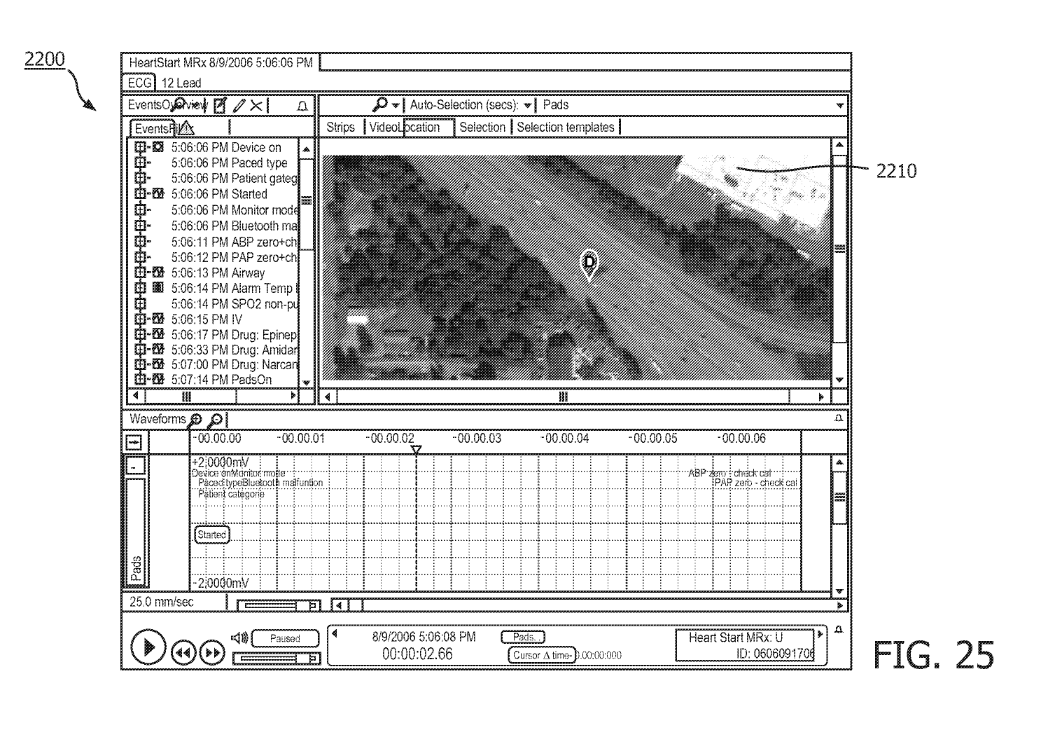

Alternatively, event data from the identified medical device may be uploaded separately to a central computer 2050 and merged with the event log in software residing therein. The means of synchronizing and displaying the integrated event data is described in more detail in the description corresponding to FIGS. 24 and 25 below. In this embodiment, the central computer 2050 will use the device identity 1510 and corresponding time markers to correlate and integrate the event data from the equipment into the event log 117.

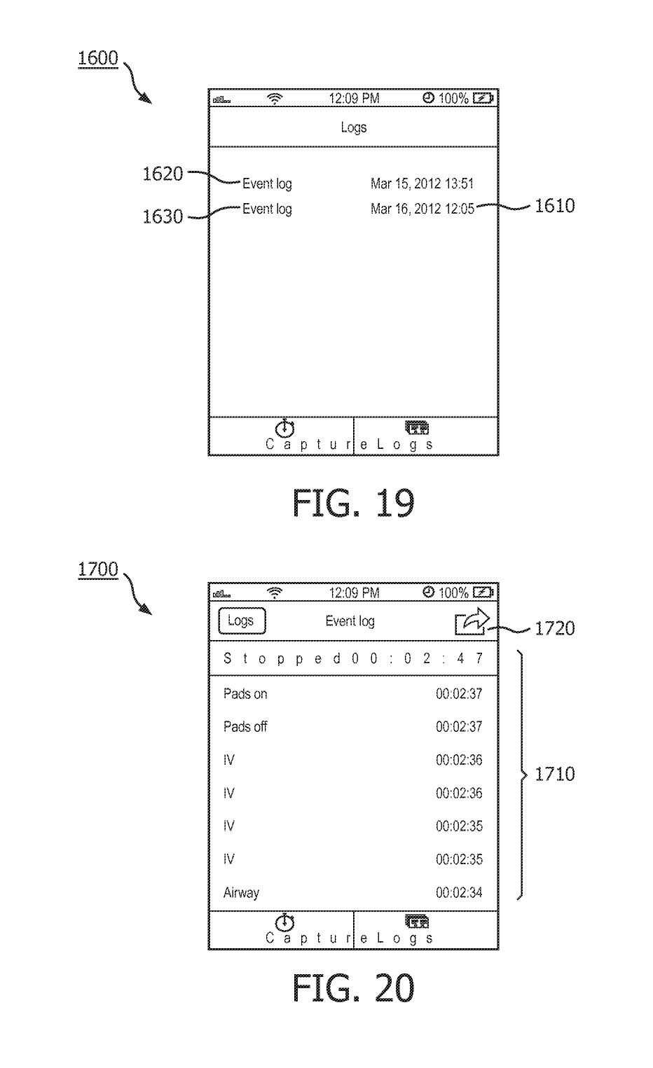

Turning now to FIG. 19, one embodiment of an event logs screen 1600 on device 100 is shown. Logs screen 1600 shows the history of all event logs that have been recorded by device 100, along with their time stamp, such as event log 1610. Additional information regarding each event log also appears on the logs screen 1600. A film-shaped icon is an example of a video status indicator 1620, which indicates that a video record is part of the data logged for that event. A cloud-shaped icon is an example of an upload status indicator 1630, which indicates that the event log data has been successfully uploaded to a remote computer such as a cloud server.

Logs screen 1600 enables the user to select a particular event log for further processing. By “swiping” or double-tapping an event log 1610, the event log is deleted from the device 100 memory, but will not be automatically deleted from any remote computer. Tapping the event log 1610 once will open the event log and navigate the user to the event log entries screen 1700 for further evaluation or processing.

A typical event log entries screen 1700 is illustrated in FIG. 20. Log entries screen 1700 shows an event log listing 1710 of annotations captured by the event log selected at screen 1600. Each annotation can be reviewed by swiping or scrolling the listing 1710. When the user touches the log action icon 1720, device 100 navigates to the log action screen 1800, which includes further processing options for the selected event log.

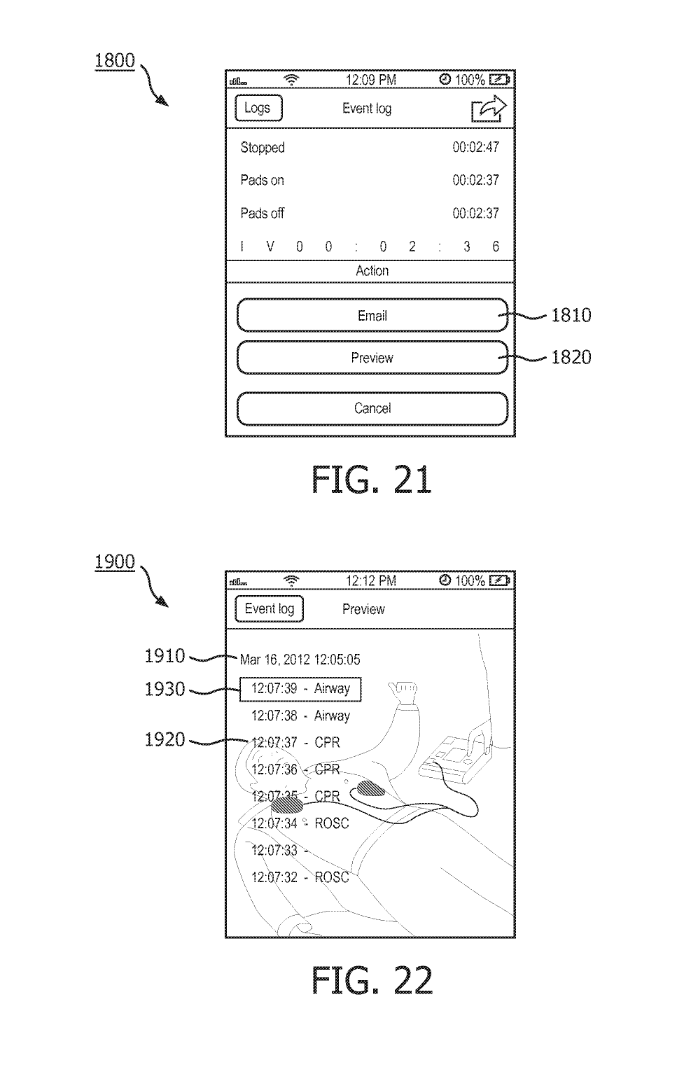

FIG. 21 illustrates one embodiment of a log action screen 1800. Device 100 presents the user several processing options in action screen 1800. A touch of log email icon 1810 creates an email containing the event log, preferably in an XML file format, along with an associated video record. The resulting email contains the same files and data which are uploaded to the remote computer as indicated by the video status indicator 1620. Preferably, the email information is encrypted in order to comply with regulatory requirements and privacy restrictions, e.g., HIPAA requirements.

A preferred XML log file contains identifying information such as start date and time. In addition the event log includes all annotations and timestamps for the medical treatment event, and may include one or more of the identities and roles of team members, device identifications, and positional location information such as GPS positioning information of the location of the event.

A touch of the log preview icon 1820 controls device 100 to navigate to a log preview screen 1900, as illustrated in FIG. 22, and initiates the playing back of the audio and video records of the selected medical treatment event on the display screen. An event log identifier 1910 at the top of screen 1900 shows the event log being previewed. The log preview screen 1900 plays back the video record overlaid by the list of each event annotation 1920. When played, the list of annotations scrolls in synchronization with the video, by displaying annotations which correspond generally in time with the current time in the video. For more precise synchronization, the current event annotation which is the last event prior to the current time in the video is enclosed by a graphic 1930 such as a box. When the user is satisfied with the event log, she touches an event log icon to return to the previous screen 1800. The event log may then processed as previously described.

FIG. 23 illustrates a system for transferring a medical treatment event record from handheld computing device 100 to a central computer 2050 for further analysis and storage according to one embodiment of the present invention. As shown in FIG. 23, handheld computing device 100 uploads each event log immediately after recording to a remote computer-readable medium 2020 via a wireless communication path 2010. The remote medium 2020 is preferably a distributed computer server, such as a cloud storage server, that can be accessed from any device having an internet connection. The wireless communication path 2010 is preferably a telephonic or wireless internet path, although wired, proprietary or secure communications circuits residing within a hospital area are contemplated as well. Remote computer-readable medium 2020 then stores the event log data until it is needed by central computer 2050.

Central computer 2050 accesses the event log data from remote computer-readable medium 2020 via a second communication path 2030 that is controlled by a download and merge tool 2040. One example of the download and merge tool 2040 is implemented in the Event Review software manufactured by Philips Healthcare of Andover, Mass. The download and merge tool 2040 can integrate ancillary data from the same medical treatment event into the event log. Ancillary data includes manually-entered data from other reports, ECG strips and physiological data from the patient, medical treatment and device status events as recorded by other medical devices, and the like.

One problem with synchronizing data from multiple sources for the same medical treatment event has been to properly sort the data by time. Although elapsed time is relatively accurate, the recorded start time may vary between each source due to clock differences, different activation times, and so on. One embodiment of the present invention incorporates several ideas to accurately account for time differences. First, no relative time errors will be introduced if the device 100 obtains data directly from the medical device as the event occurs. Alternatively, each recording device can be time-synchronized with an independent time source, such as a cellular telephone system time. Third, the download and merge tool 2040 can identify markers of the same occurrence in both devices. For example, a shock delivery occurrence would be recorded by both the device 100 and the defibrillator used in the rescue. The merge tool 2040 can identify and synchronize such markers in order to bring both timelines into correspondence. Video from device 100 where the medical device is in the field of view can be used to identify event occurrences, such as a flashing light on the defibrillator to indicate a shock has been delivered. The video marker is then used to synchronize the defibrillator log with the device 100 event log. Finally, if both devices obtain an audio record, the software can time-shift the audio of one of the events until both audio tracks are synchronized. The time-shift preferably also causes the synchronization of the other recorded annotations.

The integrated report as developed by the download and merge tool 2040 is stored in central computer 2050 for further display and manipulation at display 2060. An administrator or medical analyst may then operate central computer display 2060 to review the medical treatment event.

A review and analysis program residing on the central computer 2050 arranges the event log data for post-event review by an administrator or manager. The aforementioned Event Review software provides this functionality. FIG. 24 illustrates one embodiment of an annotation and video preview screen 2100 that is a novel modification of an Event Review screen. In this embodiment, data and annotations from a defibrillator and the handheld computing device 100 have been merged into an integrated event log for the medical treatment event prior to display. The merged annotations are listed in chronological order in an event tree 2110. The event tree may be scrolled, expanded to show more detailed information about the annotation, or collapsed as desired.

Some or all of the annotations appearing in the event tree 2110 may also be plotted on a merged annotation timeline 2130. The timeline 2130 is a more graphical-appearing event record generally having a sweep bar that marks the current time. In the FIG. 24 embodiment, an ECG obtained from the merged defibrillator data and the merged annotations are superimposed on the timeline 2130. Audio from the event may also be played as the time bar progresses.

A novel feature of the annotation and video preview screen 2100 is the simultaneous display of recorded medical event video 2120 that is synchronized with the progress of the annotation timeline 2130. The reviewing software may include a video control bar 2140 having standard video controls for the user to manipulate the play-back. Of course, the control of the video also controls the sweep bar, and vice versa, so that all records remain time-synchronized as they are reviewed. In addition, if audio from multiple sources exists in the event log, the volume level of each audio track can be controlled separately.

The medical event video 2120 significantly enhances the ability of the user to analyze the effectiveness of the medical treatment, identify performance deficiencies meriting further training, or even to evaluate whether the particular treatment protocol requires modification.

The review and analysis program on central computer 2050 may further include locating information for the event log on a location preview screen 2200. FIG. 25 illustrates one embodiment of location preview screen 2200. By selecting a location tab on the display, a location display 2210 having a map over which the location data is plotted replaces the event video. The location display 2210 assists the user in determining whether variations in transport time, traffic conditions, or routing impacted the effect of the treatment provided.

Modifications to the device, software, and displays as described above are encompassed within the scope of the invention. For example, the appearance and arrangement of displays may differ somewhat than shown in the exemplary illustrated embodiments. Different user controls which are incorporated into the handheld computing device 100, but which perform essentially the same functions as described, fall within the scope of the invention.

1. A handheld computing device comprising:
a touch screen display;
a graphical user interface operable to display an annotation icon on the touch screen display, wherein the annotation icon is illustrative of a step of a medical treatment protocol being administered to a human graphic;
a memory for storing an event log of a medical treatment of a patient provided by the medical treatment protocol; and
a processor, responsive to sensing a touch of the annotation icon as displayed by the touch screen display, operable to store an annotation of the step of the medical treatment protocol within the event log.

2. The handheld computing device of claim 1, wherein the medical treatment protocol is a cardiac resuscitation protocol, and wherein the annotation icon is one of a defibrillator electrode pad icon, a ventilation icon, a chest compression icon, a defibrillation shock delivery icon, or an intravenous (IV) therapy treatment icon.

3. The handheld computing device of claim 1, wherein a storage of the annotation of the step of the medical treatment protocol by the processor within the event log causes the graphical user interface to change an appearance of the annotation icon as displayed by the touch screen display.

4. The handheld computing device of claim 1, wherein the graphical user interface is further operable to display an annotation counter on the touch screen display, and wherein the annotation counter indicates a count of a number of sensed touches of the annotation icon by the processor.

5. The handheld computing device of claim 1, wherein the graphical user interface is further operable to display an elapsed time counter on the touch screen display as an indication of an elapsed time from an initial storage of the event log by the memory.

6. The handheld computing device of claim 1 further comprising a video camera,
wherein a video from the video camera is simultaneously displayable with the annotation icon and the human graphic on the touch screen display.

7. The handheld computing device of claim 1, wherein the annotation icon comprises an administered therapeutic agent icon.

8. The handheld computing device of claim 7, wherein the graphical user interface is further operable to display a touch-sensitive list of candidate therapeutic agents on the touch screen display, and
wherein the candidate therapeutic agents are associated with the medical treatment, of the patient.

9. The handheld computing device of claim 8, wherein the processor, responsive to sensing a touch of one of the candidate therapeutic agents as displayed by the touch screen display,
is further operable to store an annotation pertaining to the sensed touch of the candidate therapeutic agent in the event log.

10. The handheld computing device of claim 1, wherein the graphic user interface is further operable to display a crash cart icon on the touch screen display wherein the processor, responsive to sensing a touch of the crash cart icon as displayed by the touch screen display, is further operable to display a touch-sensitive list of names and roles of team members on the touch screen display, and wherein the processor, responsive to sensing a touch of a team member as displayed by the touch screen display, is further operable to store an annotation pertaining to the team member in the event log.

11. The handheld computing device of claim 1, further comprising a barcode reader which is operable to automatically detect a medical device identification barcode.

12. The handheld computing device of claim 11, wherein the medical device identification barcode identifies a medical device, and wherein the processor is further operable to store an annotation pertaining to the identified medical device in the event log.

13. The handheld computing device of claim 1, wherein the processor is further operable to upload the stored event log to a remote computer-readable medium via a wireless communications path, and wherein the processor is further operable to display a status of the upload on the touch screen display.

14. The handheld computing device of claim 1, wherein the graphical user interface is further operable to display a start icon on the touch screen display, and wherein the processor, responsive to sensing a touch of the start icon as displayed on the touch screen display, is further operable to initiate a video recording of the medical treatment of the patient.

15. (canceled)

16. (canceled)

17. (canceled)

18. (canceled)

19. (canceled)

20. (canceled)

21. The handheld computing device of claim 1,
wherein the graphical user interface is further operable to display a video preview icon on touch screen display, and
wherein the processor, responsive to sensing a touch of the video preview icon as displayed on the touch screen display, is further operable to play back a video recording of the medical treatment, of the patient.
